(19) United States
(12) Patent Application Publication
(10) Pub. No.: US 2010/0145926 A1
(43) Pub. Date: Jun. 10, 2010

(54) SYSTEM FOR PROVIDING ADVERTISEMENTS AND METHOD THEREOF

(75) Inventor: Jong-Ook Jeong, Seongnam-si (KR)

Correspondence Address: LEXYOUME IP GROUP, LLC, 5180 PARKSTONE DRIVE, SUITE 175, CHANTILLY, VA, 20151, US

(73) Assignee: J4AD Co., Ltd., Seoul (KR)

(21) Appl. No.: 12/594,614

(22) PCT Filed: Apr. 3, 2008
(86) PCT No.: PCT/KR2008/001892

§ 371 Date: Oct. 5, 2009

(30) Foreign Application Priority Data
Apr. 5, 2007 (KR) 10-2007-0033776
Aug. 16, 2007 (KR) 10-2007-0082160

(51) Int. Cl. G06F 17/30

(52) U.S. Cl. 707/709; 707/E17.108

(57) ABSTRACT

The present invention relates to an advertisement providing system and a method thereof. The advertisement providing system provides a web page including at least one of web page information, news information, and blog information to a user terminal, and extracts an advertisement keyword of information selected by the user in correspondence to web page provision. When the information selected by the user is an internal page, a web page corresponding to the selected information is provided to the user terminal, advertisement contents matching the extracted advertisement keyword and the number of steps included in user action information are selected and provided based on advertisement register information including a plurality of advertisement contents matching the advertisement keyword and the number of steps, and user action information is updated based on the user action provided by the user terminal. Accordingly, advertisement efficiency can be substantially increased by continuously providing the advertisement desired by the advertisement provider to the user through the number of steps.

### TECHNICAL FIELD

The present invention relates to an advertisement providing system and method thereof, and in particular, it relates to an advertisement providing system and method thereof for providing a series of advertisement contents for a keyword to a user, and performing an efficient billing process for an advertisement provider based on advertisement contents.

### BACKGROUND ART

Currently, the most generally-used online advertisement methods are banner advertisement, popup advertisement, flash advertisement, user created contents (UCC) advertisement, and keyword search advertisement.

The banner/popup/flash/UCC advertisements represent a scheme for putting an advertisement screen at a predetermined position of a web site to link it to the web site of the advertisement provider. The advertisements include various contents covering from general text to moving pictures, and are terminated with a single exposure (primary exposure).

The keyword search advertisement represents an advertisement scheme exposed by a search result for a keyword input by the user, and exposes an advertisement that matches the keyword received from the user so that further users may access the advertisement provider site. The keyword search advertisement is terminated with a single exposure.

The above-noted banner advertisement, popup advertisement, flash advertisement, UCC advertisement, and keyword search advertisement are provided in various manners through the web sites, but have the following problems.

Since the banner advertisement, popup advertisement, flash advertisement, and UCC advertisement are randomly displayed to the Internet users, it is very difficult to provoke the user's interests and verify the actual advertisement effects. Also, the advertisement effects are poor since the advertisement is exposed once to the user or a single advertisement is provided to him.

Since the keyword search advertisement provides the advertisement only when the advertisement matches the keyword and the provided advertisement is terminated with a single exposure, the advertisement effects are very low and it is very difficult to verify the degree of the real advertisement effects.

Together with these problems, since the expenses for the banner advertisement, popup advertisement, flash advertisement, UCC advertisement, and keyword search advertisement are appropriated based on the advertisement cost with respect to exposure without determining the actual advertisement effects, a web site generating many exposures generates a large amount of advertisement costs to thus increase the advertisement provider's expense.

The above information disclosed in this Background section is only for enhancement of understanding of the background of the invention and therefore it may contain information that does not form the prior art that is already known in this country to a person of ordinary skill in the art.

### DETAILED DESCRIPTION

### Technical Problem

The present invention has been made in an effort to provide an advertisement providing system and method thereof for providing a series of advertisement contents for a keyword to a user, and performing an efficient billing process for an advertisement provider based on advertisement contents provision.

### Technical Solution

An exemplary embodiment of the present invention provides an advertisement providing system for providing a web page including an advertisement keyword to a user terminal, including: a first contents providing device for selecting an advertisement keyword included in the web page extracted by a user action provided by the user terminal and first advertisement contents matching a number of steps performed by the user based on stored advertisement register information including a plurality of advertisement contents matching an advertisement keyword and a number of steps, providing them to the user terminal, and collecting user action information for the user's web page movement from the user terminal, the user action information including the number of steps performed by the user and the extracted advertisement keyword; a second contents providing device for, when the user terminal is connected through the first advertisement contents, receiving the user action information from the first contents providing device, providing second advertisement contents to the user terminal based on the number of steps and the keyword included in the user action information, and updating the user action information based on the user action; and an advertisement providing device for receiving the advertisement register information from an advertisement provider, providing the same to the first and second contents providing devices, and billing the advertisement providers with grades based on the user action information.

The user action information further includes action generation web page information for the user's web page movement and reaction information including action finish web page information, and the advertisement providing device bills the advertisement provider with grades based on the reaction information and the number of steps included in the user action information.

Another embodiment of the present invention provides a method for providing an advertisement in a device for providing a web page to a user terminal, including: receiving user action information on the user terminal connected through the first contents providing device from a first contents providing device for providing contents, the user action information including a number of steps and an advertisement keyword generated by the user's page movement; selecting advertisement contents matching the advertisement keyword and the number of steps included in the user action information and providing them to the user terminal based on stored advertisement register information including a plurality of advertisement contents matching an advertisement keyword and a number of steps; and updating the user action information based on the user action provided by the user terminal.

The step of updating user action information includes: providing a page including at least one of web page information, news information, and blog information to the user terminal; extracting an advertisement keyword of information selected by the user according to the page provision; when the information selected by the user is an internal page, providing a page corresponding to the selected information to the user terminal; selecting and providing the extracted advertisement keyword and advertisement contents matching the number of steps included in the user action information based on the advertisement register information; and updating the user action information based on the user action provided by the user terminal.

Yet another embodiment of the present invention provides a method for providing an advertisement in a device for providing a web page to a user terminal, including: providing a page including at least one of web page information, news information, and blog information to the user terminal; extracting an advertisement keyword of information selected by the user in correspondence to the page provision; determining whether the information selected by the user is an internal page; and when the information is an internal page according to the determination result, selecting advertisement contents matching the extracted advertisement keyword and the number of steps based on the stored advertisement register information including a plurality of advertisement contents matching the advertisement keyword and the number of steps, and providing the selected advertisement contents to the user terminal.

The step of providing the advertisement contents to the user terminal includes: searching the advertisement contents stored in the advertisement register information base on the extracted advertisement keyword and the number of steps; increasing the number of steps by a predetermined number; and providing the internal page and the searched advertisement contents to the user terminal.

According to an embodiment of the present invention, a system for providing a web page including an advertisement keyword to a user terminal includes: a first contents providing device for selecting first advertisement contents matching an advertisement keyword extracted by a user action provided by the user terminal, a number of steps performed by the user, and predetermined match/mismatch information based on stored advertisement register information, providing them to the user terminal, and collecting user action information on the user's web page movement from the user terminal, the advertisement register information including a plurality of advertisement contents matching the advertisement keyword and the number of steps and match/mismatch information for providing single or a series of advertisement contents for the advertisement keyword, and the user action information including the number of steps based on the user action and the extracted advertisement keyword; a second contents providing device, when the user terminal is connected through the first advertisement contents, for receiving the user action information from the first contents providing device, providing second advertisement contents matching the number of steps included in the user action information, the advertisement keyword, and the match/mismatch information to the user terminal based on the advertisement register information, and updating the user action information based on the user action; and an advertisement providing device for receiving the advertisement register information from an advertisement provider, providing it to the first and second contents providing devices, and billing the advertisement providers with grades based on the user action information.

The user action information further includes reaction information including action generation web page information for the user's web page movement and action finish web page information, and the advertisement providing device bills the advertisement providers with grades based on the number of steps included in the user action information, the reaction information, and established match/mismatch information.

According to an embodiment of the present invention, a method for providing an advertisement in a device for providing a web page to a user terminal includes: receiving user action information on the user terminal connected through the first contents providing device from the first contents providing device for providing contents, the user action information including the number of steps generated by the user's page movement and the advertisement keyword; selecting the advertisement keyword and the number of steps included in the user action information and the advertisement contents matching the match/mismatch information based on stored advertisement register information, and providing them to the user terminal, the advertisement register information including advertisement contents matching the advertisement keyword and the number of steps and match/mismatch information for providing a single or series of advertisement contents for the advertisement keyword; and updating the user action information based on the user action provided by the user terminal.

The step of providing the advertisement contents to the user terminal includes: determining whether to provide advertisement contents matching the advertisement keyword based on match/mismatch information of the advertisement register information; and when providing advertisement contents matching the advertisement keyword according to the determination result, providing a series of advertisement contents to the user terminal based on the advertisement keyword and the number of steps.

### ADVANTAGEOUS EFFECTS

The advertisement providing system according to the exemplary embodiment of the present invention performs an efficient graded billing process for the advertisement provider based on the points of user action information caused by provision of advertisement contents to a user terminal so that the expenses of the advertisement providers caused by the advertisement cost may be substantially reduced.

Further, since the series of advertisements desired by the advertisement provider are provided to the user according to a number of steps, the advertisement efficiency is greatly increased.

Also, since the contents providing device seamlessly provides match or mismatch advertisement contents for the number of steps to the user terminal based on the keyword received from the user terminal or the keyword extracted by a user action, the user can seamlessly receive advertisement contents according to the steps (page movement), thereby anticipating the effects of substantially increasing the advertisement efficiency.

In addition, the effect of providing an efficient graded billing process to the advertisement provider based on the points caused by the number of steps and match/mismatch information is provided.

### BRIEF DESCRIPTION OF THE DRAWINGS

FIG. 1 shows a detailed block diagram of an advertisement providing system according to a first exemplary embodiment of the present invention.

FIG. 2 shows a detailed block diagram of an advertisement providing device of an advertisement providing system according to a first exemplary embodiment of the present invention.

FIG. 3 shows a detailed block diagram of a first contents providing device of an advertisement providing system according to a first exemplary embodiment of the present invention.

FIG. 4 shows tables of user action information provided to an advertisement providing device by a first contents providing device according to a first exemplary embodiment of the present invention.

FIG. 5 shows a data flowchart of an advertisement providing method by an advertisement providing system according to a first exemplary embodiment of the present invention.

FIG. 6 shows a flowchart of an advertisement keyword buying process by an advertisement providing system according to a first exemplary embodiment of the present invention.

FIG. 7 shows a data flowchart of an advertisement providing method by an advertisement providing system according to a second exemplary embodiment of the present invention.

### BEST MODE

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

Now, terms will be defined as follows.

A first page is an initial portal web page provided to a user terminal when a user terminal accesses it, and includes web page information, news information, and blog information.

An advertisement keyword is a keyword registered by an advertisement provider so as to provide advertisement contents, and it matches advertisement contents.

A keyword includes information extracted from the link address selected by a user action such as clicking or information (search word) received from the user by using a search engine, and it is used as information for providing advertisement contents when it corresponds to the advertisement keyword.

Match/mismatch information is established by the advertisement provider, and it establishes whether to provide advertisement contents that match the advertisement keyword or whether to provide an advertisement that mismatches the advertisement keyword.

A step represents a movement from the current web page to another web page.

A step advertisement represents an advertisement scheme for providing contents for a single advertisement or a series of advertisements for the advertisement keyword to the user terminal based on the number of steps generated according to the user's web page movement (step), and the advertisement contents are established to match the advertisement keyword and the number of steps.

Advertisement register information indicates information registered by an advertisement provider so as to provide advertisements, includes a plurality of advertisement contents matched with an advertisement keyword and the number of steps, an advertisement provider ID, and site access information, and it may further include match/mismatch information for providing a single advertisement or a series of advertisements for the advertisement keyword. For example, when the advertisement keyword is “car,” it is matched with the advertisement contents for the number 1 of steps when the number of steps is 1, and it is matched with the advertisement contents for the number 2 of steps when the number of steps is 2.

Site access information includes web page access address matched with the advertisement contents.

The search engine represents a program for searching web pages on the Internet, and it searches web pages matched with or similar to the input keyword for a desired topic.

User action information is generated according to the user's action, and includes a keyword, action information (also referred to as reaction information), the number of steps, a user uniform resource locator (URL), an action time, an action generation URL, a page movement URL, and an action finish URL.

An advertisement providing system and method thereof according to an exemplary embodiment of the present invention will be described with reference to accompanying drawings.

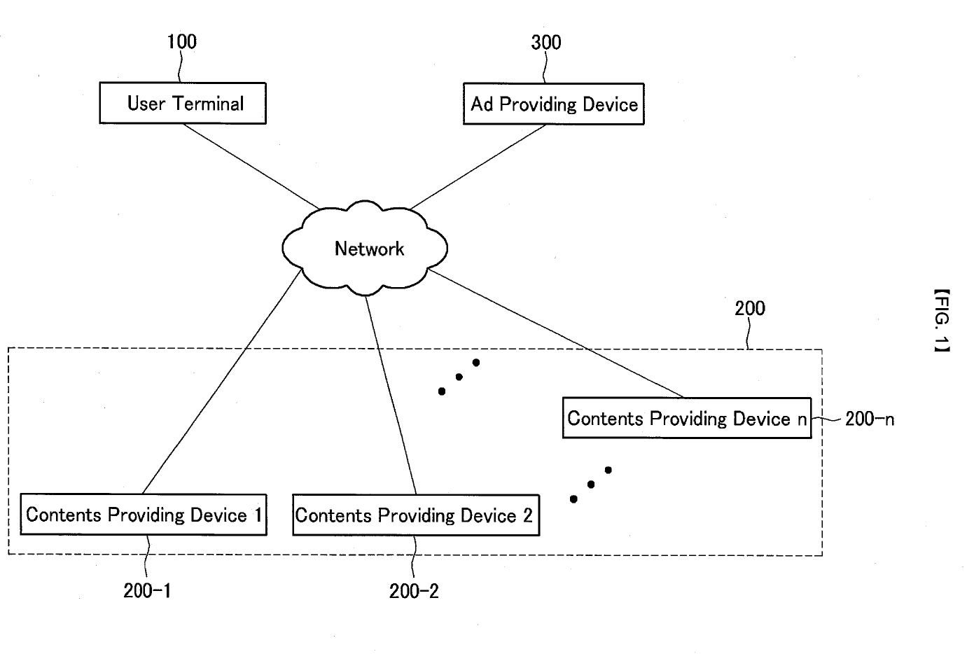

Referring to FIG. 1, an advertisement providing system according to a first exemplary embodiment of the present invention will now be described.

FIG. 1 shows a detailed block diagram of an advertisement providing system according to a first exemplary embodiment of the present invention.

As shown in FIG. 1, the advertisement providing system includes an advertisement providing device 300 and a contents providing device 200, and it is connected to a user terminal 100 through the network to transmit/receive data.

The advertisement providing device 300 provides an advertisement keyword buying providing function to the advertisement provider, stores the advertisement keyword bought by the advertisement provider, receives advertisement register information matched with the advertisement keyword from the advertisement provider, and stores it. In this instance, the advertisement providing device 300 provides the advertisement register information provided by the advertisement provider to the contents providing device 200.

Also, the advertisement providing device 300 stores user action information provided by the contents providing device 200 as statistic information, and generates and stores billing settlement information for the advertisement provider based on the stored statistic information.

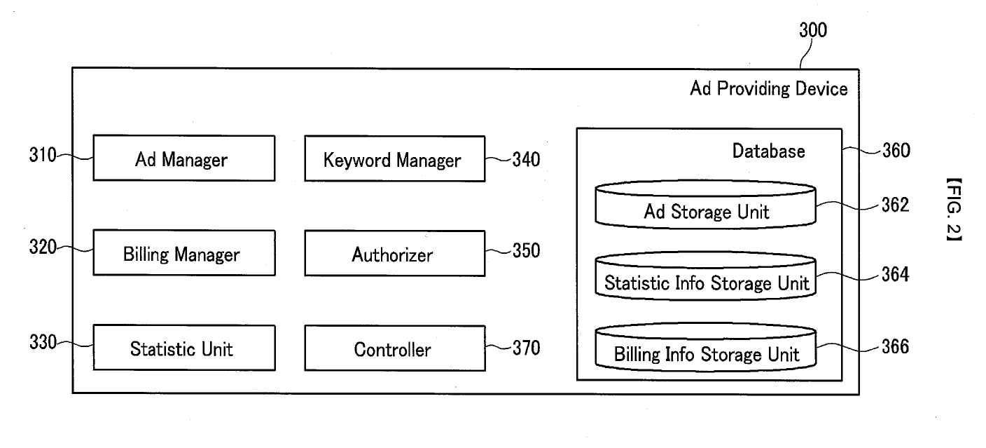

The advertisement providing device 300 will be described in detail later with reference to FIG. 2.

The contents providing device 200 receives the advertisement register information from the advertisement providing device 300 and stores it, provides a first page based on the access by the a user terminal 100, and collects user action information by the user terminal 100 according to first page provision. In this instance, the first page is a web page provided to the user terminal 100 when the user terminal 100 is connected, and it includes web page information, news information, and blog information.

Also, the contents providing device 200 includes a search engine function, and when receiving a keyword search request including a keyword from the user terminal 100, it provides a search result page including a search result corresponding to the received keyword, and collects user action information generated by the user terminal 100 according to search result page provision. In this instance, the contents providing device 200 can provide advertisement contents of the advertisement keyword matched with the received keyword together with the search result.

In this instance, the contents providing device 200 extracts the keyword of the link address selected by the user based on the user action (click) provided by the user terminal 100 according to provision of the search result page or the first page, and when the selected link address is an internal page of the contents providing device, it provides the advertisement contents and the internal page based on the extracted keyword and the number of steps to the user terminal 100, and then extracts the keyword of the link address selected by the user based on the user action and repeatedly provides the advertisement contents based on the extracted keyword and the number of steps. When the selected link address is not an internal page of the contents providing device, the contents providing device 200 provides the collected user action information to the advertisement providing device 300 or another contents providing device.

Also, when receiving user action information generated by the user terminal 100 from the other contents providing device, the contents providing device 200 provides corresponding advertisement contents of advertisement register information to the user terminal 100 based on the number of steps and the keyword included in the user action information.

Here, the advertisement contents provided by the contents providing device 200 to the user terminal 100 based on the number of steps and the keyword are advertisement contents for providing the same advertisement or advertisement contents for providing a series of advertisements matched with the number of steps.

When the advertisement contents provided to the user terminal 100 are clicked by the user, the contents providing device 200 increases the number of steps by 1 and provides collected user action information to the contents providing device 200 of the link address possessed by the corresponding advertisement contents so that the contents providing device of the advertisement provider may seamlessly receive the advertisement contents.

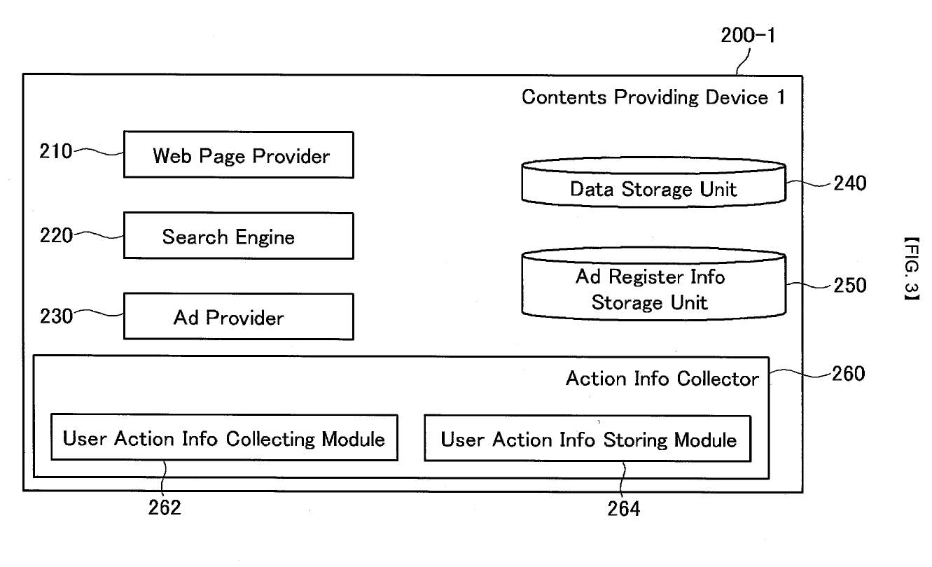

The contents providing device 200 will be described in detail later with reference to FIG. 3.

The user terminal 100 accesses the contents providing device 200 to receive a first page including web page information, blog information, and news information, and moves to the page matching the link address in the first page based on the user action (click) generated by the user.

Also, the user terminal 100 requests a keyword search including the keyword provided by the user from the contents providing device 200, receives a search result page matching the provided keyword from the contents providing device 200, provides it to the user, and moves to the web page matching the link address in the search result page based on the user action (click) generated by the user.

Here, the user terminal 100 provides the advertisement contents provided by the contents providing device 200 to the user when a page movement (a step) is generated.

Here, the user terminal 100 includes terminals (e.g., a personal computer or a radio access terminal) available for data transmitting/receiving with the contents providing device 200 through the network.

With reference to FIG. 2, an advertisement providing device of an advertisement providing system according to a first exemplary embodiment of the present invention will now be described.

FIG. 2 shows a detailed block diagram of an advertisement providing device of an advertisement providing system according to a first exemplary embodiment of the present invention.

As shown in FIG. 2, the advertisement providing device 300 includes an advertisement manager 310, a billing manager 320, a statistic unit 330, a keyword manager 340, an authorizer 350, a database 360, and a controller 370.

The advertisement manager 310 receives advertisement register information from the advertisement provider, stores it in the database 360, and manages the stored advertisement register information. The advertisement manager 310 provides the stored advertisement register information to the contents providing device 200. In this instance, the advertisement manager 310 provides cooperated site information (the address of the contents providing device that is cooperated so as to provide the advertisement to the user) stored by the managing user together with advertisement register information to the contents providing device 200.

Also, the advertisement manager 310 receives user action information for advertisement contents provision to the user terminal 100 from the contents providing device 200, and provides the received user action information to the statistic unit 330.

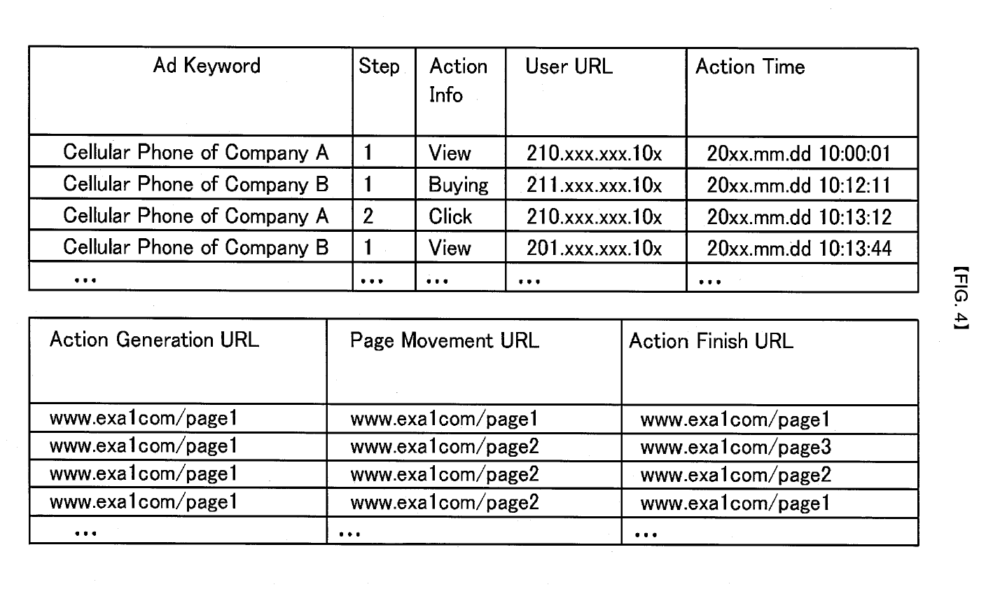

Here, user action information includes an advertisement provider identification (ID), a keyword, the number of steps, an action time, a user URL, an action information and action generation URL, a page movement URL, and an action finish URL. The user action information will be described in detail with reference to FIG. 4.

The keyword manager 340 provides an advertisement buying window (a buying web page) for buying the advertisement keyword to the advertisement provider, and receives the advertisement keyword from the advertisement provider, stores it in the database 360, and manages the stored advertisement keyword.

Here, the advertisement keyword includes a single advertisement keyword and plural advertisement keywords.

The billing manager 320 bills the advertisement provider's buying of the advertisement keyword, and bills the advertisement providers with grades.

In detail, the billing manager 320 performs a graded billing process for the advertisement providers based on the points included in statistic information. That is, the billing manager 320 generates billing settlement information for billing the advertisement providers with grades based on the points (used as scores) stored in the statistic information storage unit 364, and stores the generated billing settlement information in the billing information storage unit 366.

The above-noted advertisement providing system reduces the advertisement expense of the advertisement provider through the graded billing process on the advertisement provider for the billing manager's points compared to the conventional exposure advertisement, and performs efficient billing.

The authorizer 350 authorizes the advertisement provider and the managing user based on the stored ID/password. In this instance, the ID/password stored in the authorizer 350 is assumed to have been registered by the advertisement provider or the managing user.

Also, the authorizer 350 includes an internal authentication engine (IAE) function and a keyword filtering function.

The IAE function is an automatic verification function for the standard of the advertisement contents received from the advertisement provider, and for example, when the advertisement contents are images, it reads image header information to verify the image size, color, and configuration information, and when the advertisement contents are video, it verifies the video's format and voice information and color information. That is, the IAE function verifies whether the images or video satisfy a predetermined standard.

The keyword filtering function performs a filtering process by determining whether the keyword received from the managing user or the advertisement provider is a stored prohibited keyword.

The statistic unit 330 generates points for respective advertisement providers based on the user action information provided by the contents providing device 200, and stores the generated point and the user action information in the statistic information storage unit 364.

In detail, the statistic unit 330 generates the points matching the stored point change information based on the number of steps and the action information included in the user action information provided by the contents providing device 200 and stores the points in the statistic information storage unit 364 according to the advertisement provider ID.

Here, the stored point change information is given in Table 1. That is, when no step is generated (when the number of steps is 0), 1, 3, and 6 points are generated according to view, click, and buying, when the step is generated once (when the number of steps is 1), 0.80, 3.15, and 7.80 points are generated, when the steps are generated twice (when the number of steps is 2), 0.64, 3.31, and 10.14 points are generated, and when the steps are generated three times (when the number of steps is 3), 0.51, 3.47, and 13.18 points are generated.

In this instance, it is possible to generate points caused by generation of steps by setting point change information for the number of steps greater than 3.

TABLE 1

| Number of steps | View | Click | Buying |
|---|---|---|---|
| Step 0 | 1.00 | 3.00 | 6.00 |
| Step 1 | 0.80 | 3.15 | 7.80 |
| Step 2 | 0.64 | 3.31 | 10.14 |
| Step 3 | 0.51 | 3.47 | 13.18 |

The database 360 includes an advertisement storage unit 362, a statistic information storage unit 364, and a billing information storage unit 366.

The advertisement storage unit 362 is linked with the advertisement manager 310 and the keyword manager 340, stores the advertisement keyword provided by the keyword manager 340, and stores advertisement register information matching the advertisement keyword provided by the advertisement manager 310.

Also, the advertisement storage unit 362 stores information on the cooperated sites stored by the managing user.

The statistic information storage unit 364 is controlled and managed by the statistic unit 330, and stores statistic information provided by the statistic unit 330.

The billing information storage unit 366 is controlled and managed by the billing manager 320, and stores billing settlement information for the advertisement provider calculated by the billing manager 320.

The controller 370 controls the access and data flow between the advertisement providing device 300 and the contents providing device 200, and controls and manages the advertisement manager 310, the billing manager 320, the statistic unit 330, the keyword manager 340, the authorizer 350, and the database 360. Also, the controller 370 controls and manages data flow between the units of the advertisement providing device 300.

Referring to FIG. 3, a first contents providing device 200 of an advertisement providing system according to a first exemplary embodiment of the present invention will be described.

FIG. 3 shows a detailed block diagram of a first contents providing device of an advertisement providing system according to a first exemplary embodiment of the present invention.

As shown in FIG. 3, the first contents providing device 200-1 includes a web page provider 210, a search engine 220, an advertisement provider 230, a data storage unit 240, an advertisement register information storage unit 250, and an action information collector 260.

When the user terminal 100 is connected, the web page provider 210 provided the first page stored in the data storage unit 240, and receives a user action (click) from the user terminal 100. The web page provider 210 provides an internal page and advertisement contents provided by the advertisement provider 230 based on the user action provided by the user terminal 100.

In this instance, when the user terminal 100 is connected through another contents providing device, the web page provider 210 receives advertisement contents matching the first page and the user action information provided by the other contents providing device from the advertisement provider 230, and provides them to the user terminal 100.

Also, the web page provider 210 receives a keyword search request including a keyword from the user terminal 100, provides the received keyword to the search engine 220, and provides a search result page matching the keyword to the user terminal 100. In this instance, the web page provider 210 can receive the advertisement contents matching the received keyword and can provide the same together with the search result page.

The search engine 220 includes a search engine unit and it searches search results such as web page information on the keyword, news information, and blog information from the data storage unit 240, and provides them to the user terminal 100 through the web page provider 210.

The advertisement provider 230 receives advertisement register information from the advertisement providing device 300 and stores it, receives the keyword from the action information collector 260, and determines whether the received keyword is an advertisement keyword based on stored advertisement register information. In this instance, when the received keyword is an advertisement keyword, the advertisement provider 230 provides the advertisement contents matching the number of steps and the keyword to the web page provider 210.

The advertisement provider 230 searches advertisement contents stored in the advertisement register information storage unit 250 based on the number of steps of user action information provided by the second contents providing device 200-2 and the advertisement keyword, and provides them to the web page provider 210. In this instance, the advertisement contents provided by the advertisement provider 230 to the web page provider 210 based on the number of steps and the keyword are advertisement contents for providing the same advertisement or the advertisement contents for providing a series of advertisements matching the number of steps.

The data storage unit 240 stores web pages to be provided according to an access by the user terminal 100, and stores information (a web page corresponding to the keyword, for example, a site link) to be provided as a search result matching the keyword provided by the user terminal 100.

The advertisement register information storage unit 250 stores advertisement register information provided by the advertisement providing device 300.

The action information collector 260 includes a user action information collecting module 262 and a user action information storing module 264.

The user action information collecting module 262 extracts the keyword of the link address based on the user action (click) for clicking the provided first page, the search result page, or the link address included in the advertisement contents, and transmits the extracted keyword to the advertisement provider 230.

Also, the user action information collecting module 262 provides the keyword provided by the user to the advertisement provider 230 so that the web page provider 210 may provide the advertisement contents together with the search result page.

Also, when the user terminal 100 accesses the second contents providing device 200-2, the user action information collecting module 262 determines whether the second contents providing device 200-2 matching the clicked link address is a cooperated site based on the stored site information, and when it is a cooperated site, the user action information collecting module 262 increases the number of steps by a predetermined number (e.g., 1) to store user action information, and transmits the user action information with the increase number of steps to the second contents providing device 200-2. In this instance, when the second contents providing device 200-2 is not a cooperated site, the user action information collecting module 262 transmits collected user action information to the advertisement providing device 300 without changing the number of steps.

Also, when the user terminal 100 is connected through the second contents providing device 200-2, the user action information collecting module 262 receives user action information of the user terminal 100 from the second contents providing device 200-2 to accumulate and collect user action information on the user's action, and controls to provide advertisement contents to the advertisement provider 420.

The user action information storing module 264 stores user action information collected by the user action information collecting module 262.

In this instance, the collected user action information will be described in detail later with reference to FIG. 4.

The second contents providing device 200-2 and the n-th contents providing device have the same configurations and functions as the first contents providing device 200-1, which will not be described since it will be easily understood by a person of ordinary skill in the art through the first contents providing device 200-1.

Referring to FIG. 4, user action information transmitted to an advertisement providing device by an action information collector of a first contents providing device according to a first exemplary embodiment of the present invention will be described.

FIG. 4 shows tables of user action information provided to an advertisement providing device by a first contents providing device according to a first exemplary embodiment of the present invention.

As shown in FIG. 4, user action information according to the first exemplary embodiment of the present invention includes an advertisement provider identification (ID), an advertisement keyword, a number of steps, an action time, a user URL, action information, an action generation URL, a page movement URL, and an action finish URL.

The advertisement provider ID is an ID assigned to the advertisement provider, the advertisement keyword is a keyword for advertisement, the action time is the time when the user action is generated, and the user URL is an IP address of the user terminal.

The number of steps is the number of times in which the steps are generated. For example, when the user accesses the first contents providing device 200-1 through the user terminal to move to the second contents providing device 200-2, the step of the first stage is generated so that the number of step is 1, and when the user moved from the second contents providing device 200-2 to the n-th contents providing device 200-n again, the steps of the second stage is generated so that the number of steps is 2.

The action generation URL, the page movement URL, and the action finish URL represent a URL of the page in which an action is generated by the user, a page URL moved by the user action, and a URL of the page in which the user's action is finished.

The action information represents information on the user's actions classified as view, buying, and click based on the action generation URL, the page movement URL, and the action finish URL, and in detail, the action generation URL is a current access URL at which the user's action is generated, the page movement URL is a URL moved by the user's action, and the action finish URL is a finish URL when the connection with the user is finished.

Here, the view represents action information when the action generation URL and the action finish URL are the same, and it indicates the user is finished without page movement after having checked the web page matching a predetermined keyword (including a first page, a search result page, and a web page moved through advertisement contents).

The click represents action information for indicating the case in which the action generation URL and the action finish URL are different, and in detail, it represents the case in which the user moved to another web page through a predetermined action after checking the web page matching a predetermined keyword (including a first page, a search result page, and a web page moved through advertisement contents).

The buying is action information for indicating the case in which the action finish URL is an established URL (a settlement finish site), and the established URL is a settlement finish site for indicating the finish of buying of a specific product.

Here, user action information is collected by the action information collector 260 of the first contents providing device 200-1 shown in FIG. 3 through linkage with the web page provider 210, the search engine 220, and the advertisement provider 230.

The first contents providing device 200-1 has an advantage of providing efficient advertisement contents to the user based on the action information and the number of steps matching the keyword. Also, the advertisement providing device has an advantage of billing the advertisement provider with grades based on the user action information.

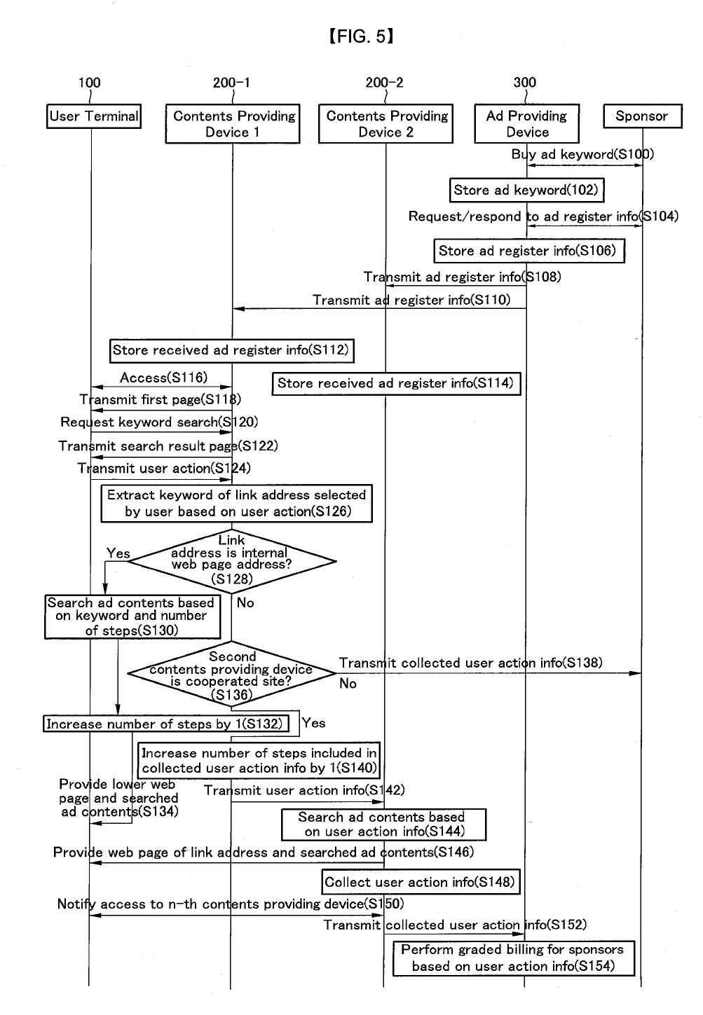

FIG. 5 shows a data flowchart of an advertisement providing method by an advertisement providing system according to a first exemplary embodiment of the present invention.

As shown in FIG. 5, the advertisement providing method is performed when the first contents providing device 200-1 receives advertisement register information registered by the advertisement provider through the advertisement providing device 300.

The advertisement providing device 300 receives an advertisement keyword from the advertisement provider through the advertisement keyword buy process and stores it (S100 and S102).

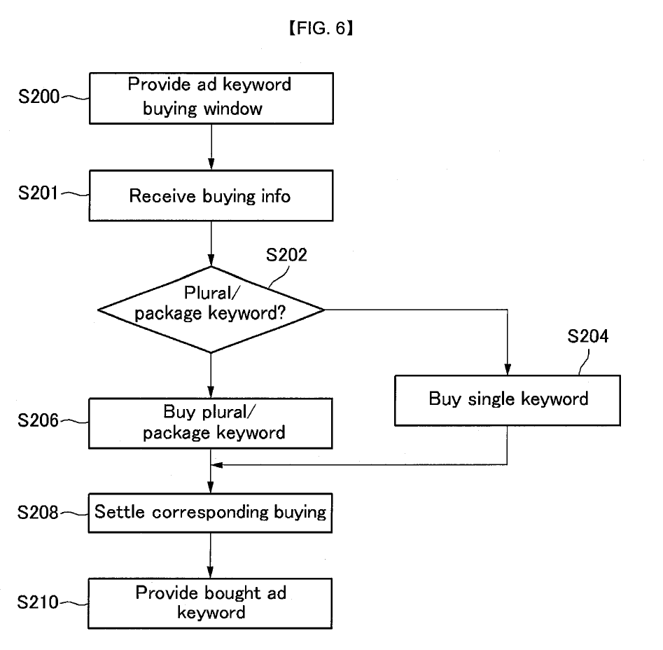

The advertisement keyword buy process will be described in detail with reference to FIG. 6.

The advertisement providing device 300 receives an advertisement keyword from the advertisement provider. The advertisement providing device 300 requests advertisement register information on the received advertisement keyword from the advertisement provider, receives advertisement register information, and stores it (S104).

The advertisement providing device 300 transmits the stored advertisement register information to the first contents providing device 200-1 and the second contents providing device 200-2 (S108 and S110).

The first contents providing device 200-1 and the second contents providing device 200-2 receive advertisement register information from the advertisement providing device 300, and stores the received advertisement register information (S112 and S114).

The first contents providing device 200-1 and the second contents providing device 200-2 establish the advertisement keyword desired by the advertisement provider, receive advertisement register information matching the advertisement keyword from the advertisement providing device 300, and store it.

The user terminal 100 accesses the first contents providing device 200-1 (S116), and receives a first page from the first contents providing device 200-1 (S118). The user terminal 100 receives a keyword search request including a keyword from the user and transmits it to the first contents providing device 200-1 (S120).

The first contents providing device 200-1 receives the keyword from the user terminal 100, performs a search engine function based on the received keyword, and provides a search result page including a search result (web page information, news information, blog information, and etc.) to the user terminal 100 (S122).

The user terminal 100 receives the search result page from the first contents providing device 200-1 and provides it to the user, and transmits the user action input by the user to the first contents providing device 200-1 (S124).

The first contents providing device 200-1 extracts the keyword of the link address selected by the user in the search result page based on the user action provided by the user terminal 100. The first contents providing device 200-1 extracts the keyword based on the title of the corresponding link of the link address, the address, or classification information (S126).

The first contents providing device 200-1 does not receive the keyword from the user terminal 100, and extracts the keyword of the link address selected by the user in the first page based on the user action corresponding to first page provision. Also, the first contents providing device 200-1 searches the advertisement contents based on the keyword provided by the user terminal 100, and provides searched advertisement contents together with the search result page.

The first contents providing device 200-1 determines whether the link address selected by the user is a web page address provided by the second contents providing device 200-2 based on the first page or search result page provision (S128).

The first contents providing device 200-1 determines whether the extracted keyword is a stored advertisement keyword when the link address selected by the user is not a web page address provided by the second contents providing device 200-2 but is an internal web page address of the first contents providing device 200-1 according to the determination result of the step S128. When the extracted keyword is an advertisement keyword, the first contents providing device 200-1 searches advertisement contents of the corresponding advertisement keyword based on the number of steps (S130).

The first contents providing device 200-1 provides stored advertisement contents when the keyword is not an advertisement keyword. In this instance, the advertisement contents provided by the first contents providing device 200-1 can be advertisement contents that are stored so as to be provided when the keyword is not an advertisement keyword, or advertisement contents that are randomly selected and provided from among stored advertisement contents.

The first contents providing device 200-1 provides the searched advertisement contents and the internal web page of the link address selected by the user to the user terminal 100 (S134). In this instance, the first contents providing device 200-1 increases the number of steps by 1 in correspondence to the page movement to the internal web page from the first page (S132).

The first contents providing device 200-1 repeats the steps after the step of S126 until the user terminal 100 is disconnected.

When the link address selected by the user is provided by the second contents providing device 200-2 according to the determination result of the step of S128, the first contents providing device 200-1 determines whether the second contents providing device 200-2 for providing the link address selected by the user is a cooperated site (S136).

When the second contents providing device 200-2 is not a cooperated site according to the determination result of the step of S130, the first contents providing device 200-1 transmits the user action information that is collected during the process from the time when the user terminal 100 is connected to the time when it moves to the second contents providing device 200-2 to the advertisement providing device 300 (S138).

When the second contents providing device 200-2 is found to be a cooperated site according to the determination result of the step of S130, the first contents providing device 200-1 transmits the user action information that is collected during the process from the time when the user terminal 100 is connected to the time when it moves to the second contents providing device 200-2 to the second contents providing device 200-2 (S142). In this instance, the first contents providing device 200-1 increases the step included in the user action information by 1 (S140) before transmitting the user action information to the second contents providing device 200-2.

The second contents providing device 200-2 provides the web page of the link address and the advertisement contents to the user terminal 100 according to the access of the user terminal 100 (S146). In this instance, the second contents providing device 200-2 receives user action information from the first contents providing device 200-1, and provides advertisement contents to the user terminal 100 based on the keyword and the number of steps included in the received user action information (S144).

The second contents providing device 200-2 collects user action information generated by the user terminal 100 according to the web page and advertisement contents provision.

The second contents providing device 200-2 collects information generated by the user action before the user terminal 100 notifies the access to the n-th contents providing device 200-n (S148), and determined whether the n-th contents providing device 200-n is a cooperated site when receiving a notice of the access to the n-th contents providing device 200-n from the user terminal.

When the n-th contents providing device 200-n is not a cooperated site, the second contents providing device 200-2 transmits the collected user action information to the advertisement providing device 300 (S150). In this instance, when the n-th contents providing device 200-n is a cooperated site, the second contents providing device 200-2 increases the step of the collected user action information by 1 and transmits it to the n-th contents providing device 200-n.

The advertisement providing device 300 receives user action information from the contents providing device 200 (S152), and calculates statistic information on the received user action information based on the stored advertisement register information. That is, the advertisement providing device 300 calculates the points based on the user action information (the number of steps and action information).

The advertisement providing device 300 bills the advertisement providers with grades according to a predetermined billing process based on the statistic information calculated by a predetermined period (e.g., a month) (S154).

In this instance, in the predetermined billing process, the advertisement providing device 300 collects points of the corresponding advertisement provider from the statistic information at regular predetermined periods (e.g., per month), and provides billing settlement information including billing information to be settled by the advertisement provider to the advertisement provider based on the collected points.

The advertisement providing system has an advantage of reducing a large amount of expenses of the advertisement providers caused by the advertisement expense by efficiently billing the advertisement providers with grades based on the point information included in the statistic information.

Referring to FIG. 6, an advertisement keyword buying process by an advertisement providing device according to a first exemplary embodiment of the present invention will be described.

FIG. 6 shows a flowchart of an advertisement keyword buying process by an advertisement providing system according to a first exemplary embodiment of the present invention.

As shown in FIG. 6, the advertisement buy process of the advertisement providing device 300 according to the first exemplary embodiment of the present invention is performed when an advertisement provider accesses the advertisement providing device 300 through an advertisement provider terminal.

The advertisement providing device 300 provides an advertisement keyword buying window for providing buying information on a plural/package advertisement keyword or a single advertisement keyword to an advertisement provider (S200), and receives advertisement keyword buying information from the advertisement provider (S201).

The advertisement providing device 300 determines whether the received advertisement keyword buy information is a plural/package advertisement keyword (S202), and when it is not a plural/package advertisement keyword, the advertisement providing device 300 determines it to be a single advertisement keyword buying and settles the corresponding buying (S204 and S208).

When it is found to be the buying for the plural/package advertisement keyword according to the determination result of the step of S202, advertisement providing device 300 settles the corresponding buying (S206 and S208).

The advertisement providing device 300 provides the bought advertisement keyword to the advertisement provider (S210), receives advertisement register information on the advertisement keyword from the advertisement provider according to advertisement keyword provision, and stores it.

Here, the single advertisement keyword is an advertisement keyword, the package advertisement keyword is a bundle of mutually related advertisement keywords, and the plural advertisement keywords are a bundle of single advertisement keywords.

The advertisement providing system has an advantage of providing advertisement contents for the single or plural keywords desired by the advertisement provider by providing an advertisement keyword buying to the advertisement provider.

The advertisement providing system according to the first exemplary embodiment of the present invention can differentially bill the advertisement providers by further including match or mismatch information (setting information about providing whether advertisement contents matching the advertisement keyword or advertisement contents mismatching the advertisement keyword) established by the advertisement provider in the user action information. An advertisement providing system according to a second exemplary embodiment of the present invention will be described with reference to constituent elements of FIG. 1 to FIG. 3.

In the advertisement providing system and method according to the second exemplary embodiment of the present invention, parts that can be easily understood by a person of ordinary skill in the art through the advertisement providing system and method according to the first exemplary embodiment of the present invention will not be described.

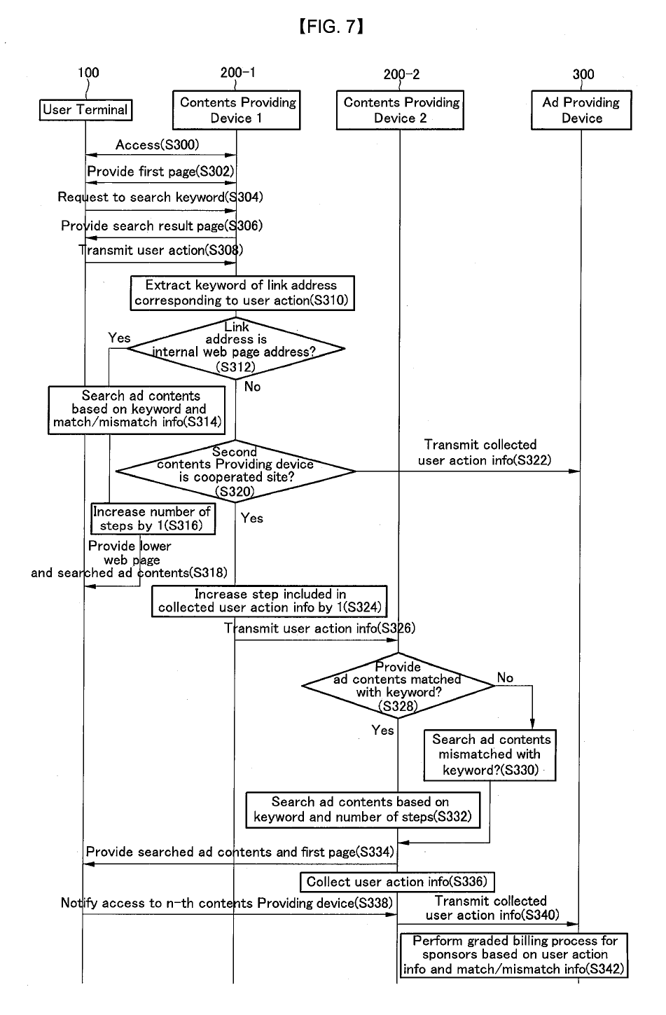

An advertisement providing system and a first contents providing device according to a second exemplary embodiment of the present invention will be described with reference to FIG. 1 to FIG. 3, and an advertisement providing method according to a second exemplary embodiment of the present invention will be described with reference to FIG. 7.

An advertisement providing system according to a second exemplary embodiment of the present invention will now be described with reference to FIG. 1 to FIG. 3.

The advertisement providing system according to the second exemplary embodiment of the present invention includes an advertisement providing device 300 and a contents providing device 200, and transmits/receives data to/from the user terminal 100 connected thereto through a network.

The advertisement providing device 300 includes an advertisement manager 310, a keyword manager 340, a billing manager 320, an authorizer 350, a statistic unit 330, and a database 360, and each device includes functions matching each device of the advertisement providing device according to the first exemplary embodiment.

When receiving advertisement register information for providing advertisement contents matching the advertisement keyword to the user terminal 100 from the advertisement provider, the advertisement manager 310 receives and stores match/mismatch information of whether to provide a match advertisement or a mismatch advertisement in the case of providing a step advertisement.

The advertisement manager 310 transmits advertisement register information including match/mismatch information to the contents providing device 200.

Here, the advertisement register information includes an advertisement keyword, advertisement contents, an advertisement provider ID, match/mismatch information, and site access information.

The statistic unit 330 receives user action information including the number of steps from the contents providing device 200, and generates points based on the received number of steps and stored match/mismatch information.

In detail, the statistic unit 330 generates the points matching the stored point change information based on the number of steps and match/mismatch information, and stores them in the statistic information storage unit 364.

Here, the point change information is expressed in Table 2.

TABLE 2

| Match | | | | Mismatch | | | |
|---|---|---|---|---|---|---|---|
| No. of | | | | No. of | | | |
| steps | View | Click | Buying | steps | View | Click | Buying |
| Step 0 | 1.00 | 3.00 | 6.00 | Step 0 | 3.00 | 6.00 | 18.00 |
| Step 1 | 0.90 | 3.15 | 7.20 | Step 1 | 2.40 | 6.60 | 27.00 |
| Step 2 | 0.81 | 3.31 | 8.64 | Step 2 | 1.92 | 7.26 | 40.50 |
| Step 3 | 0.73 | 3.47 | 10.37 | Step 3 | 1.54 | 7.99 | 60.75 |

A first contents providing device according to a second exemplary embodiment of the present invention will now be described.

The first contents providing device 200-1 includes a web page provider 210, an advertisement provider 230, a data storage unit 240, an advertisement register information storage unit 250, and an action information collector 260.

When the first contents providing device 200-1 receives user action information from the second contents providing device 200-2 according to the access by the user terminal 100, the first contents providing device 200-1 provides advertisement contents to the user terminal 100 based on the stored match/mismatch information and the number of steps and the keyword included in the user action information.

In detail, the first contents providing device 200-1 checks match/mismatch information on the advertisement keyword, and provides the same advertisement contents to the user terminal based on the number of steps and the keyword when the match/mismatch information is established to be a mismatch. In this instance, when the match/mismatch information is established to be a match, the first contents providing device 200-1 provides advertisement contents matching the number of steps to the user terminal 100 so as to provide a series of advertisements.

The action information collector 260 includes a user action information collecting module 232 and a user action information storing module 234.

The first contents providing device 200-1 provides the same advertisement contents to the user terminal 100 in the case of a mismatch based on the match/mismatch information established by the advertisement provider, and provides a series of advertisements in the case of a match, so that the advertisement effects for the advertisement keyword desired by the advertisement provider can be maximized. Particularly, the same advertisement for the “cellular phone of company A” of the advertisement provider can be repeatedly provided according to the user's web page movement (step) as a match advertisement for the “cellular phone of company A” extracted by the user's clicking of a web page, and a series of advertisements for the “cellular phone of company B” of the advertisement provider can be sequentially provided according to the user's web page movement (step) as a mismatch advertisement, thereby maximizing the advertisement effects.

The second contents providing device 200-2 and the n-th contents providing device have the same configuration and function as the first contents providing device 200-1, and will not be described since it will be easily understood by a person of ordinary skill in the art through the first contents providing device 200-1.

An advertisement providing method of an advertisement providing system according to a second exemplary embodiment of the present invention will be described with reference to FIG. 7.

FIG. 7 shows a data flowchart of an advertisement providing method by an advertisement providing system according to a second exemplary embodiment of the present invention.

As shown in FIG. 7, the advertisement providing method by the advertisement providing system according to the second exemplary embodiment of the present invention is performed when the first contents providing device 200-1 and the second contents providing device 200-2 receive advertisement register information registered by the advertisement provider through the advertisement providing device 300.

In this instance, the advertisement register information received by the first contents providing device 200-1 and the second contents providing device 200-2 is provided by the advertisement providing device 300 through an established predetermined advertisement keyword buying process, and the advertisement keyword buying process will not be described since it will be easily understood by a person of ordinary skill in the art through the advertisement providing method according to the first exemplary embodiment of the present invention.

However, the advertisement providing device 300 in the advertisement providing method according to the second exemplary embodiment of the present invention receives match/mismatch information from the advertisement provider, and transmits advertisement register information including match/mismatch information to the first contents providing device 200-1 and the second contents providing device 200-2. In this instance, match/mismatch information is setting information on providing whether advertisement contents (single advertisement contents) mismatching the keyword received from the user terminal 100 or advertisement contents (a series of advertisement contents) matching the same.

The first contents providing device 200-1 and the second contents providing device 200-2 stores advertisement register information provided by the advertisement providing device 300 based on the advertisement keyword.

The user terminal 100 accesses the first contents providing device 200-1 (S300), and receives a first page from the first contents providing device 200-1 (S302). The user terminal 100 receives a keyword search request including a keyword from the user and transmits it to the first contents providing device 200-1 (S304).

The first contents providing device 200-1 provides a search result page including a search result (web page information, news information, blog information, and etc.) to the user terminal 100 by performing a search engine function based on the keyword provided by the user terminal 100 (S306).

The user terminal 100 receives the search result page from the first contents providing device 200-1 and provides the same to the user, and transmits the user action input by the user to the first contents providing device 200-1 (S308).

The first contents providing device 200-1 receives a user action (click) from the user terminal 100, and extracts the keyword of the link address selected by the user in the search result page based on the received user action (S310). The first contents providing device 200-1 extracts the keyword based on the title, address, or classification information possessed by the corresponding link of the link address.

The first contents providing device 200-1 searches the advertisement contents based on the keyword provided by the user terminal 100, and provides searched advertisement contents together with the search result page. Also, the first contents providing device 200-1 does not receive the keyword from the user terminal 100, and can extract the keyword of the link address selected by the user in the first page based on the user action corresponding to first page provision.

The first contents providing device 200-1 determines whether the link address selected by the user is an internal web page address provided by the first contents providing device 200-1 based on the first page or the search result page provision (S312).

When the link address selected by the user is an internal web page address of the first contents providing device 200-1 according to the determination result of the step of S312, the first contents providing device 200-1 determines whether the extracted keyword is a stored advertisement keyword. When the extracted keyword is an advertisement keyword, the first contents providing device 200-1 searches match/mismatch information of the stored advertisement register information and advertisement contents matching or mismatching the advertisement keyword based on the current number of steps (S314).

Here, when it is set to provide the advertisement contents matching the advertisement keyword and the user terminal 100 generates a web page movement (step) to the same keyword, the first contents providing device 200-1 provides a series of advertisement contents to the user terminal 100 based on the number of steps, and when it is set to provide the advertisement contents mismatching the advertisement keyword and the user terminal 100 generates a web page movement (step) to the same keyword, the first contents providing device 200-1 provides the same advertisement contents to the user terminal 100.

The first contents providing device 200-1 provides the internal web page of the link address selected by the user together with the searched advertisement contents to the user terminal 100 (S318). The first contents providing device 200-1 increases the number of steps by 1 in response to the page movement to the internal web page address in the first page 1 (S316).

When the link address selected by the user is not the internal web page address of the first contents providing device 200-1 but it is provided by the second contents providing device 200-2 according to the determination result of the step of S312, the first contents providing device 200-1 determines whether the second contents providing device 200-2 for providing the link address selected by the user is a cooperated site (S320).

When the second contents providing device 200-2 is not a cooperated site according to the determination result of the step of S320, the first contents providing device 200-1 transmits the user action information that is collected during the process from the time when the user terminal 100 is connected to the time when it is moved to the second contents providing device 200-2 to the advertisement providing device 300 (S322).

When the second contents providing device 200-2 is a cooperated site according to the determination result of the step of S320, the first contents providing device 200-1 transmits the user action information that is collected during the process from the time when the user terminal 100 is connected to the time when it moves to the second contents providing device 200-2 to the second contents providing device 200-2 (S326). In this instance, the first contents providing device 200-1 increases the step included in the user action information by 1 before transmitting the user action information to the second contents providing device 200-2 (S324).

The second contents providing device 200-2 receives user action information from the first contents providing device 200-1, and determines whether to provide the advertisement contents matching the advertisement keyword included in the user action information based on the match/mismatch information of the stored advertisement register information (S328).

When providing the advertisement contents mismatching the keyword (not when providing the matching advertisement contents) according to the determination result of the step of S328, the second contents providing device 200-2 searches the advertisement contents that are established to be provided when mismatching the keyword (S330). In this instance, the advertisement contents that are set to be provided when mismatching the keyword are single advertisement contents including advertisement content.

When the advertisement contents matching the keyword are provided according to the determination result of the step of S328, the second contents providing device 200-2 searches advertisement contents based on the keyword and the number of steps so as to provide a series of advertisements (S332).

The second contents providing device 200-2 provides the searched advertisement contents and the first page to the user terminal 100 (S334), and collects user action information generated by the user terminal 100 according to the advertisement contents and first page provision (S336).

The second contents providing device 200-2 collects information that is generated by the user action before the user terminal 100 notifies the access to the n-th contents providing device 200-n, and when receiving an access notice to the n-th contents providing device 200-n from the user terminal, it determines whether the n-th contents providing device 200-n is a cooperated site.

When the n-th contents providing device 200-n is not a cooperated site, the second contents providing device 200-2 transmits the collected user action information to the advertisement providing device 300 (S340).

In this instance, when the n-th contents providing device 200-n is a cooperated site, the second contents providing device increases the step of the collected user action information by 1, and transmits it to the n-th contents providing device 200-n.

The advertisement providing device 300 receives user action information from the contents providing device 200, and calculates statistic information on the received user action information based on the stored advertisement register information. That is, the advertisement providing device 300 calculates the points based on the user action information (the number of steps, match/mismatch information, and action information).

The advertisement providing device 300 bills the advertisement providers with grades according to the established billing process based on statistic information calculated at the established period (e.g., per month) (S342).

In the advertisement providing method according to the second exemplary embodiment of the present invention, since the contents providing device consecutively provides match or mismatch advertisement contents for the number of steps to the user terminal based on the keyword provided by the user terminal or the keyword detected by a user action, the user can continuously receive the advertisement contents as the user's step (page movement), thereby substantially increasing the advertisement effects.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. In a system for providing a web page including an advertisement keyword to a user terminal, an advertisement providing system comprising:
a first contents providing device for selecting an advertisement keyword included in the web page extracted by a user action provided by the user terminal and first advertisement contents matching a number of steps performed by the user based on stored advertisement register information including a plurality of advertisement contents matching an advertisement keyword and a number of steps, providing them to the user terminal, and collecting user action information for the user's web page movement from the user terminal, the user action information including the number of steps performed by the user and the extracted advertisement keyword;
a second contents providing device for, when the user terminal is connected through the first advertisement contents, receiving the user action information from the first contents providing device, providing second advertisement contents to the user terminal based on the number of steps and the keyword included in the user action information, and updating the user action information based on the user action; and
an advertisement providing device for receiving the advertisement register information from an advertisement provider, providing the same to the first and second contents providing devices, and billing the advertisement providers with grades based on the user action information.

2. The advertisement providing system of claim 1, wherein
the user action information further includes action generation web page information for the user's web page movement and reaction information including action finish web page information, and
the advertisement providing device bills the advertisement provider with grades based on the reaction information and the number of steps included in the user action information.

3. The advertisement providing system of claim 2, wherein
the first contents providing device and the second contents providing device respectively include:
a web page provider for transmitting/receiving data to/from the user terminal, and providing the web page and advertisement contents;
an advertisement provider for searching advertisement contents based on the advertisement keyword and the number of steps, and providing the searched advertisement contents to the web page provider; and
a user action information collector for extracting an advertisement keyword of a link address selected by the user in correspondence to the web page provision, providing the extracted advertisement keyword to the advertisement provider, collecting the user action information in linkage with the web page provider, and transmitting the user action information to the advertisement providing device.

4. The advertisement providing system of claim 3, wherein
the first contents providing device and the second contents providing device respectively include
a search engine for, when the web page provider receives a keyword from the user terminal in correspondence to web page provision, performing a search engine function for the received keyword, and providing the search result based on the search to the web page provider so that the search result may be provided to the user terminal, and
the advertisement provider searches advertisement contents based on the advertisement keyword matching the keyword received through the search engine, and provides the advertisement contents to the web page provider.

5. The advertisement providing system of claim 3, wherein
the user action information collector includes:
an action information storing module for storing the collected user action information; and
an action information collecting module for collecting the user action information in linkage with the web page provider, storing the user action information in the action information storing module, and transmitting the stored user action information in the advertisement providing device.

6. The advertisement providing system of claim 2, wherein
the advertisement providing device includes:
a keyword manager for providing an advertisement keyword buying process to the advertisement provider, and storing the advertisement keyword bought by the advertisement provider;
an advertisement manager for receiving and storing the advertisement register information matching the bought advertisement keyword, and providing the advertisement register information to the first contents providing device and the second contents providing device;
a statistic unit for generating and storing points corresponding to the number of steps and the reaction information based on stored point change information;
a billing unit for billing the advertisement providers with grades based on the points stored in the statistic unit; and
a controller for controlling and managing the keyword manager, the advertisement manager, the statistic unit, and the billing unit.

7. The advertisement providing system of claim 6, further comprising
an authorizer, controlled by the controller, for authorizing the advertisement provider and the managing user, verifying the standard of the advertisement contents, and filtering the advertisement keyword.

8. The advertisement providing system of claim 7, wherein the system comprises:
a first storage unit for storing the advertisement register information;
a second storage unit for storing the user action information and points of the statistic unit; and
a third storage unit for storing billing information calculated by the billing unit so as to bill the advertisement provider.

9. The advertisement providing system of claim 2, wherein
the reaction information includes at least one of a view action for the case in which an action generation page and an action finish page are the same, a click action for the case in which the action generation web page and the action finish web page are different, and a buying action for the case in which the action finish web page is an established page for indicating a settlement finish.

10. A method for providing an advertisement in a device for providing a web page to a user terminal, the method comprising:
receiving user action information on the user terminal connected through the first contents providing device from a first contents providing device for providing contents, the user action information including a number of steps and an advertisement keyword generated by the user's page movement;
selecting advertisement contents matching the advertisement keyword and the number of steps included in the user action information and providing them to the user terminal based on stored advertisement register information including a plurality of advertisement contents matching an advertisement keyword and a number of steps; and
updating the user action information based on the user action provided by the user terminal.

11. The advertisement providing method of claim 10, wherein
the step of updating user action information includes:
providing a page including at least one of web page information, news information, and blog information to the user terminal;
extracting an advertisement keyword of information selected by the user according to the page provision;
when the information selected by the user is an internal page, providing a page corresponding to the selected information to the user terminal;
selecting and providing the extracted advertisement keyword and advertisement contents matching the number of steps included in the user action information based on the advertisement register information; and
updating the user action information based on the user action provided by the user terminal.

12. The advertisement providing method of claim 11, further comprising
increasing the number of steps by a predetermined number, after the step of providing the extracted advertisement keyword and advertisement contents matching the number of steps included in the user action information.

13. The advertisement providing method of claim 11, wherein the method includes:
when the information selected by the user is not an internal page and is provided by the second contents providing device, determining whether the second contents providing device is a cooperated site;
when the second contents providing device is found to be a cooperated site according to the determination result, increasing the number of steps by a predetermined number; and
including the number of steps increased by the predetermined number in the user action information to update the user action information, and transmitting the updated user action information to the second contents providing device.

14. The advertisement providing method of claim 13, further comprising,
when the second contents providing device is not a cooperated device according to the determination result, transmitting the collected user action information to an advertisement providing device for billing the advertisement providers with grades.

15. A method for providing an advertisement in a device for providing a web page to a user terminal, the method comprising:
providing a page including at least one of web page information, news information, and blog information to the user terminal;
extracting an advertisement keyword of information selected by the user in correspondence to the page provision;
determining whether the information selected by the user is an internal page; and
selecting advertisement contents matching the extracted advertisement keyword and the number of steps based on the stored advertisement register information including a plurality of advertisement contents matching the advertisement keyword and the number of steps, and providing the selected advertisement contents to the user terminal when the information is an internal page according to the determination result.

16. The advertisement providing method of claim 15, wherein
the step of providing the advertisement contents to the user terminal includes:
searching the advertisement contents stored in the advertisement register information base on the extracted advertisement keyword and the number of steps;
increasing the number of steps by a predetermined number; and
providing the internal page and the searched advertisement contents to the user terminal.

17. The advertisement providing method of claim 16, further comprising,
after the step of providing the internal page and the searched advertisement contents to the user terminal,
collecting user action information on the user's web page movement from the user terminal based on the internal page and the searched advertisement contents provision, the user action information including action information, an extracted advertisement keyword, and the number of steps caused by the user's web page movement.

18. The advertisement providing method of claim 17, wherein the method includes:
determining whether a first contents providing device is a cooperated site when the information selected by the user is not an internal page and is provided by the first contents providing device;
increasing the number of steps by a predetermined number when the first contents providing device is a cooperated site according to the determination result; and
including the number of steps increased by the predetermined number in the user action information, and transmitting the same to the first contents providing device.

19. The advertisement providing method of claim 18, further comprising
transmitting the collected user action information to an advertisement providing device for billing the advertisement providers with grades when the first contents providing device is not a cooperated device according to the determination result.

20. The advertisement providing method of claim 18, further comprising,
before the step of providing the page,
receiving registered advertisement register information from the advertisement providing device based on the advertisement provider's plural/package or single advertisement keyword buying, and storing the advertisement register information.

21. The advertisement providing method of claim 17, wherein
the step of providing the page includes:
receiving a keyword for searching a web page from the user; and
providing a page including at least one of web page information, news information, and blog information relating to the keyword for the search to the user terminal.

22. A system for providing a web page including an advertisement keyword to a user terminal, the system comprising:
a first contents providing device for selecting first advertisement contents matching an advertisement keyword extracted by a user action provided by the user terminal, a number of steps performed by the user, and predetermined match/mismatch information based on stored advertisement register information, providing them to the user terminal, and collecting user action information on the user's web page movement from the user terminal, the advertisement register information including a plurality of advertisement contents matching the advertisement keyword and the number of steps and match/mismatch information for providing single or a series of advertisement contents for the advertisement keyword, and the user action information including the number of steps based on the user action and the extracted advertisement keyword;
a second contents providing device, for when the user terminal is connected through the first advertisement contents, receiving the user action information from the first contents providing device, providing second advertisement contents matching the number of steps included in the user action information, the advertisement keyword, and the match/mismatch information to the user terminal based on the advertisement register information, and updating the user action information based on the user action; and
an advertisement providing device for receiving the advertisement register information from an advertisement provider, providing it to the first and second contents providing devices, and billing the advertisement providers with grades based on the user action information.

23. The advertisement providing system of claim 22, wherein
the user action information further includes reaction information including action generation web page information for the user's web page movement and action finish web page information, and
the advertisement providing device bills the advertisement providers with grades based on the number of steps included in the user action information, the reaction information, and established match/mismatch information.

24. The advertisement providing system of claim 23, wherein
the advertisement providing device generates points corresponding to the number of steps included in the user action information provided by the first contents providing device or the second contents providing device, reaction information, and match/mismatch information based on stored point change information, and billing the advertisement providers with grades based on the points.

25. The advertisement providing system of claim 22, wherein
the first contents providing device and the second contents providing device respectively perform a search engine function when receiving the keyword input by the user from the user terminal, and provide advertisement contents for the search result acquired through the search engine function and the advertisement keyword matching the received keyword to the user terminal through the page.

26. A method for providing an advertisement in a device for providing a web page to a user terminal, the method comprising:
receiving user action information on the user terminal connected through the first contents providing device from the first contents providing device for providing contents, the user action information including the number of steps generated by the user's page movement and the advertisement keyword;
selecting the advertisement keyword and the number of steps included in the user action information and the advertisement contents matching the match/mismatch information based on stored advertisement register information, and providing them to the user terminal, the advertisement register information including advertisement contents matching the advertisement keyword and the number of steps and match/mismatch information for providing a single or series of advertisement contents for the advertisement keyword; and
updating the user action information based on the user action provided by the user terminal.

27. The advertisement providing method of claim 26, wherein
the step of providing the advertisement contents to the user terminal includes:
determining whether to provide advertisement contents matching the advertisement keyword based on match/mismatch information of the advertisement register information; and
when providing advertisement contents matching the advertisement keyword according to the determination result, providing a series of advertisement contents to the user terminal based on the advertisement keyword and the number of steps.

28. The advertisement providing method of claim 27, further comprising,
when not providing advertisement contents matching the advertisement keyword according to the determination result, providing single advertisement content to the user terminal based on the advertisement keyword and the number of steps.

29. The advertisement providing method of claim 28, wherein
the step of updating the user action information includes:
providing a page including at least one of web page information, news information, and blog information to the user terminal;
extracting an advertisement keyword of information selected by the user in correspondence to the page provision;
when the information selected by the user is an internal page, providing the web page corresponding to the selected information to the user terminal;
selecting advertisement contents matching the extracted advertisement keyword, the number of steps of the user action information, and the match/mismatch information based on the advertisement register information, and providing the same to the user terminal; and
updating the user action information based on the user action provided by the user terminal.

30. The advertisement providing method of claim 29, wherein the method includes,
when the information selected by the user is not an internal page is a second contents providing device, determining whether the second contents providing device is a cooperated site,
when the second contents providing device is a cooperated site according to the determination result, increasing the number of steps by a predetermined number, and
including the number of steps increased by the predetermined number in the user action information, and transmitting it to the second contents providing device.

31. The advertisement providing method of claim 30, wherein further including,
when the second contents providing device is not a cooperated site according to the determination result, transmitting the collected user action information to an advertisement providing device for billing the advertisement providers with grades.
